(19) United States
(12) Patent Application Publication
(10) Pub. No.: US 2009/0310198 A1
(43) Pub. Date: Dec. 17, 2009

(54) SCANNER

(75) Inventors: Ki-Suk Woo, Seoul (KR); Chang-Keun Jun, Siheung-si (KR); Joo-Hong Kim, Hwaseong-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/471,282

(22) Filed: May 22, 2009

(30) Foreign Application Priority Data
Jun. 17, 2008 (KR) 10-2008-0057048

(51) Int. Cl. G02B 26/10

(52) U.S. Cl. 359/200.7

(57) ABSTRACT

A scanner is disclosed that includes: a mirror, which may be formed on a light path, and which may reflect incident light; a mirror holder, which may support the mirror; a housing, which may rotatably support the mirror holder; two driving coils, which may be secured to the housing, formed symmetrically about the rotational shaft of the mirror holder; and a driving magnet, which may be coupled to the mirror holder, to be inserted inside the two driving coils. This scanner can be utilized to reflect rays of light in a stable manner to form a more even image.

### CROSS-REFERENCE TO RELATED APPLICATIONS

This application claims the benefit of Korean Patent Application No. 10-2008-0057048 filed with the Korean Intellectual Property Office on Jun. 17, 2008, the disclosure of which is incorporated herein by reference in its entirety.

### BACKGROUND

1. Technical Field

The present invention relates to a scanner, more particularly to a scanner used in a display device.

2. Description of the Related Art

A scanner is a device which reflects rays of light to form an image on a screen, and may be used in a barcode reader or a display device, etc. While there have been active development efforts geared towards implementing ultra-small scanners, to apply scanners in portable equipment or cell phones, the opportunities for expanding the functionality and for popularizing the products are limited by the small size of the display unit in the portable equipment or cell phones to which the scanners may be applied.

In a scanner according to the related art, the driving force of a driving unit may periodically rotate a mirror in an oscillating manner, so that rays received from a light source may be modulated by an optical modulator to form an image on the screen. Here, the driving force provided by the driving unit may be a force generated by the interaction between a coil and a magnet. In this case, the torque generated by the relative position changes of the magnet and coil may provide low linearity, which can lead to a lower degree of evenness in the image.

That is, according to the related art, when the mirror is oscillated periodically, the position and speed of the mirror may not be controlled with high precision, posing difficulties in forming an even image. Also, there is no structure for supplementing the driving force, so that power may be wasted when the rotating direction of the mirror is changed.

As such, there is a need for a scanner, and a display device equipped with the scanner, which can reflect rays of light and form an even, high-resolution image in a stable manner, and which are equipped with an apparatus for supplementing the driving force of the driving unit.

### SUMMARY

An aspect of the invention provides a scanner that can reflect rays of light in a stable manner to form a more even image.

Another aspect of the invention provides a scanner that includes: a mirror, which may be formed on a light path, and which may reflect incident light; a mirror holder, which may support the mirror; a housing, which may rotatably support the mirror holder; two driving coils, which may be secured to the housing, formed symmetrically about the rotational shaft of the mirror holder; and a driving magnet, which may be coupled to the mirror holder, to be inserted inside the two driving coils.

The scanner may further include a supplementing part that can provide a supplementary rotational force that supplements the rotation of the mirror holder at a position where the rotating direction of the mirror holder is changed. The supplementing part can be an elastic member, configured to provide an elastic force to the mirror holder.

Yet another aspect of the invention provides a scanner that includes: a mirror, which may be formed on a light path, and which may reflect incident light; a mirror holder, which may support the mirror; a housing, which may rotatably support the mirror holder; two driving magnets, which may be secured to the housing, formed symmetrically about the rotational shaft of the mirror holder; and a driving coil, which may be coupled to the mirror holder in such a way that allows the two driving magnets to be inserted inside the driving coil.

The scanner may further include a supplementing part that can provide a supplementary rotational force that supplements the rotation of the mirror holder at a position where the rotating direction of the mirror holder is changed. The supplementing part can be an elastic member, configured to provide an elastic force to the mirror holder.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram of a display device equipped with a scanner according to an embodiment of the invention.

FIG. 2, FIG. 3, and FIG. 4 are diagrams of a scanner according to an embodiment of the invention.

FIG. 5 is a diagram of a scanner according to another embodiment of the invention.

FIG. 6 is a graph representing torque distribution for various scanner structures.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Various embodiments of the invention will now be described below in more detail with reference to the accompanying drawings. Those components that are the same or are in correspondence are rendered the same reference numeral regardless of the figure number, and redundant explanations are omitted.

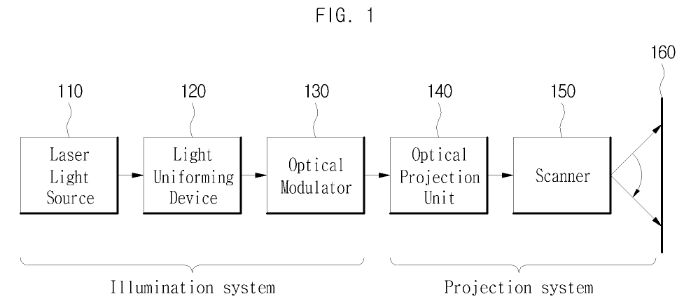

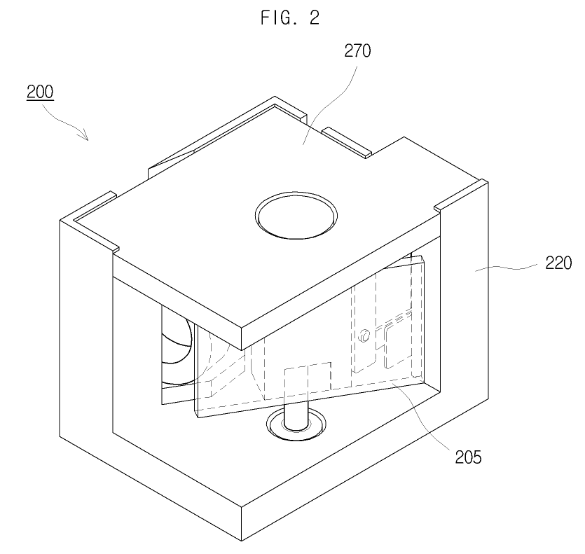

First, a description will be provided, with reference to FIG. 1, on a display device in which a scanner according to an embodiment of the invention may be used. FIG. 1 is a schematic diagram of a display device equipped with a scanner according to an embodiment of the invention.

Referring to FIG. 1, a display device according to an embodiment of the invention can include a laser light source 110, a light uniforming device 120, an optical modulator 130, an optical projection unit 140, and a scanner 150.

The laser light source 110 can be a semiconductor laser or a solid-state laser, gas laser, or liquid laser, but is not thus limited.

Rays of light emitted from the laser light source 110 can pass the light uniforming device 120 and enter the optical modulator 130. If the rays emitted from the laser light source 110 are to form an image, the light uniforming device 120 may improve the evenness of the image.

The optical modulator 130 can be composed of numerous micromirrors, which may be arranged in a row to form a line. Each of the micromirrors may correspond to a respective pixel in the picture displayed on the screen 160, where multiple micromirrors may be arranged in a line to form the optical modulator 130. Instead of inputting a point ray to each of the pixel-level micromirrors composing the optical modulator 130, a linear ray can be inputted to the linearly-shaped optical modulator 130 in a time-divisional manner, to allow each of the micromirrors to modulate the ray and allow the optical modulator 130 comprising the multiple micromirrors to output a modulated, one-dimensional linear ray. The modulated ray outputted from the overall optical modulator 130 may finally appear as a linear scanning line on the screen 160. As such linearly projected beams are sequentially projected onto the screen 160, a complete two-dimensional picture can be implemented.

The rays of light modulated by the optical modulator 130 can pass through the optical projection unit 140 to be inputted to the scanner 150, and the scanner 150 can scan the linear rays in a particular direction onto the screen 160 to form a planar picture. That is, the scanner 150 can reflect the modulated linear rays emitted from the optical modulator 130 in predetermined angles to project the rays onto the screen 160. For example, the linear rays outputted from an optical modulator 130 having a vertical orientation may be scanned along a horizontal direction on the screen 160 to complete a two-dimensional planar picture.

Here, the predetermined angles can be determined by scanner control signals inputted from an image control unit (not shown). The scanner control signals can be synchronized with image control signals, so that the scanner 150 may be rotated to such angles at which the modulated linear rays may be projected onto the screen 160 in the positions of vertical scanning lines (or horizontal scanning lines) corresponding to the image control signals. That is, the scanner control signals can include information on the driving angles and driving speeds, and the scanner 150 can be positioned to particular locations at particular times according to the driving angles and driving speeds specified. The scanner 150 can be classified into those types that utilize MEMS processes and those types that operate based on the forces generated by the interaction between a magnet and a coil. A scanner according to an embodiment of the invention may be a scanner in which the operation is powered by the interaction between a magnet and a coil.

Although it is not illustrated in FIG. 1, the laser light source 110, optical modulator 130, and scanner 150, etc., described above may be controlled by an image control unit. That is, the image control unit may include a microprocessor and may output signals for controlling electrically connected components inside the display. Also, the image control unit may transfer the scanner control signals to the scanner that allow the scanner to control the scanning of the one-dimensional images outputted from the optical modulator 130 from one side to the other, as already described above. The image control unit may also control the generation of the one-dimensional images to provide a desired brightness, by altering the position of each of the micromirrors forming the optical modulator 130 to correspond with the image signals.

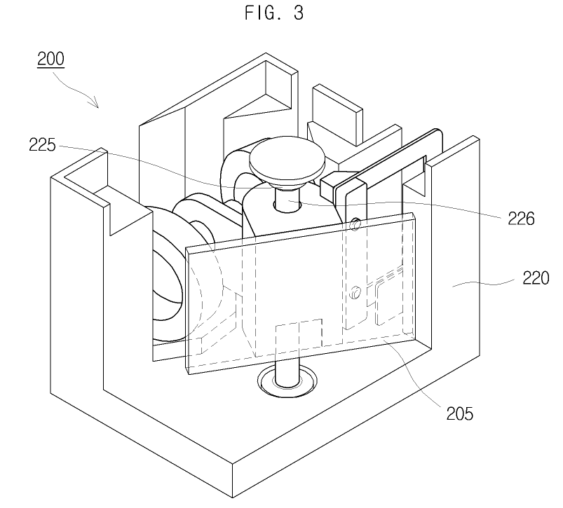

A description will now be provided as follows, with reference to FIGS. 2 to 4, on the structure of a scanner according to an embodiment of the invention. FIGS. 2 to 4 are diagrams of a scanner according to an embodiment of the invention.

In FIGS. 2 to 4, there are illustrated a scanner 200, a mirror 205, a mirror holder 210, a housing 220, a bearing 225, a rotational shaft 226, driving coils 232(1), 232(2) (hereinafter collectively referred to by the numeral 232), a driving magnet 234, a supplementing part 250, and a cover 270.

A scanner 200 based on this embodiment can display an image having improved evenness, by utilizing the linear torque characteristics obtained by the driving magnet 234 and the two driving coils 232 formed symmetrically about the rotational shaft 226 of the mirror holder 205.

As illustrated in FIG. 2, a scanner according to this embodiment may include its various components inside the housing 220, where the cover 270 can be applied to protect the components.

The mirror 205 can be positioned on a light path to reflect rays of light. That is, after the rays of light emitted from a light source are modulated by an optical modulator, the rays may be reflected by the mirror 205 to form an image on the screen.

Here, the mirror 205 can rotate in an oscillating manner at a particular frequency within a limited range of angles, whereby the modulated light may be projected onto the screen as an image. The mirror 205 may, for example, undergo oscillating rotations within a range of 20 to 22 degrees at a frequency of 100 Hz or higher.

The mirror holder 210 can support the mirror 205. That is, the mirror 205 can be secured to one side of the mirror holder 210, while the driving force generated by the coils 232 and magnet 234 can be transferred to the other side of the mirror holder 210, to allow the mirror 205 to rotate in an oscillating manner within a limited range of angles.

Here, the rotational shaft 226 can be coupled to the center of rotation of the mirror holder 210. The rotational shaft 226 can be rotatably coupled to the housing 220 by way of an interposed bearing, to allow oscillatory rotations for the mirror 205 and mirror holder 210 about the rotational shaft 226.

The housing 220 can support the mirror holder 210 in a manner that allows rotation. As described above, the rotational shaft 226 can be coupled to the rotation center of the mirror holder 210, and the rotational shaft 226 can be rotatably coupled to the housing 220. Therefore, the mirror holder 210 can be made to rotate concentrically with the rotational shaft 226.

Also, the supplementing part 250 can provide an elastic force to supplement the rotational force of the mirror holder 210, when the direction of rotation of the mirror holder 210 is changed. This will be described in further detail in the section describing the supplementing part.

The driving magnet 234 and the driving coils 232 can rotate the mirror holder 210, to allow the mirror 205 to periodically rotate in an oscillating manner. As described above, the mirror 205 can project rays of light within a limited range of angles to form an image on the screen. To do so, the driving magnet 234 and driving coils 232 can oscillatorily rotate the mirror holder 210 within the limited range of angles at a particular frequency, whereby the mirror 205 secured to the mirror holder 210 may also oscillatorily rotate within the limited range of angles at a particular frequency.

The two driving coils 232(1), 232(2) can be secured to the housing 220 and can be formed in a symmetric arrangement with respect to the rotational shaft 226 of the mirror holder 210. By regulating the amount of electric current flowing through the driving coils 232, the magnitude of the force generated by the operation of the driving coils 232 and driving magnet 234 can be adjusted. The driving magnet 234 can be coupled to the other side of the mirror holder 210 and may be inserted in the driving coils 232 according to changes in electric current flowing through the driving coils 232.

That is, when an electric current is supplied to the two driving coils 232 in one direction, the flow of electricity can generate a magnetic filed, so that the interaction between the driving coils 232 and the driving magnet 234 may create an electromagnetic force in one direction, causing the driving magnet 234 to be inserted through a driving coil 232. Conversely, when an electric current is supplied to the two driving coils 232 in the opposite direction, the electromagnetic force generated by the flow of electricity in the driving coils 232 can be applied in the other direction, so that the driving magnet 234 inserted through a driving coil 232 can be removed to the exterior.

Due to such electromagnetic forces generated by the driving coils 232 and the driving magnet 234, the mirror 205 secured to the mirror holder 210 can also undergo oscillatory rotation within a limited range of angles at a particular frequency. That is, the electromagnetic forces generated between the driving coils 232 and the driving magnet 234 can be applied as torque for rotating the mirror 205, whereby the mirror 205 can be made to rotate within a limited range of angles at a particular frequency.

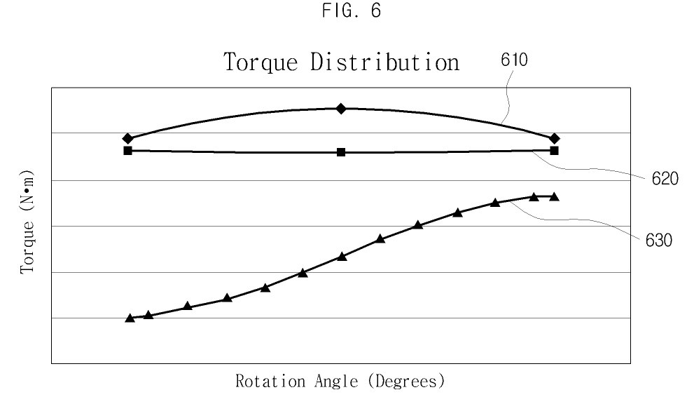

Here, the two driving coils 232 interacting with the driving magnet 234 can be formed in symmetry to each other about the rotational shaft of the mirror holder 210. The two symmetrically formed driving coils 232 can provide improved linearity in the characteristics of the torque generated, compared to the conventional case of using one driving magnet 234 and one driving coil 232. That is, forming the driving coils 232 symmetrically may ensure a symmetrical property also in the characteristics of the torque generated, while the magnitude of the torque may also be doubled compared to the case when only one driving coil 232 is formed. The linearity in torque characteristics that may be obtained using symmetry will be described later in further detail with reference to FIG. 6.

When the rotating direction is changed, during the course of the oscillatory rotation of the mirror holder 210, the supplementing part 250 can provide a rotational force that supplements the rotation of the mirror holder 210, where the supplementing part 250 can be an elastic member providing an elastic force on the mirror holder 210. The elastic force can be a spring, such as a leaf spring, that has one end coupled to the mirror holder 210 and the other end supported by the housing 220 to provide an elastic force according to the rotation of the mirror holder 210.

With the supplementing part 250 coupled to the mirror holder 210, an elastic force can be provided onto the mirror holder 210 when the rotating direction of the mirror holder 210 is changed during the course of the oscillatory rotation. Thus, the mirror holder 210 may oscillatorily rotate with greater ease, and as a result, the power consumption of the scanner 200 may be reduced. As such, the sizes of the driving coils 232 and driving magnet 234 can be decreased, and a more compact scanner 200 can be implemented.

The operation of the mirror holder 210 can be facilitated using the supplementing part 250, as the elastic force of the supplementing part 250 may not be applied before the change in rotating direction, i.e. when the mirror holder 210 is rotating, to reduce any waste in power consumption for the driving magnet 234 and driving coils 232, and the elastic force of the supplementing part 250 may only be applied near the points where the rotating direction of the mirror holder 210 is changed.

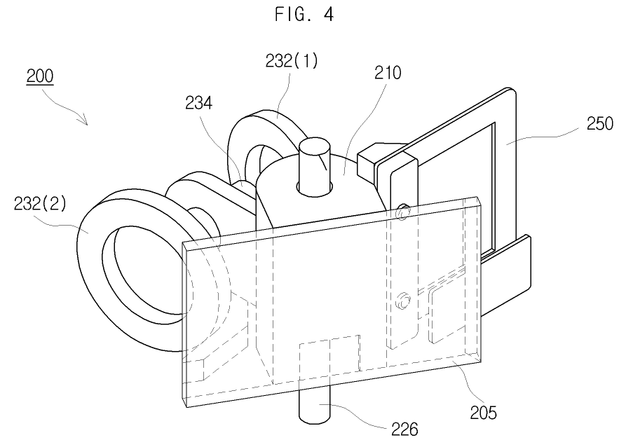

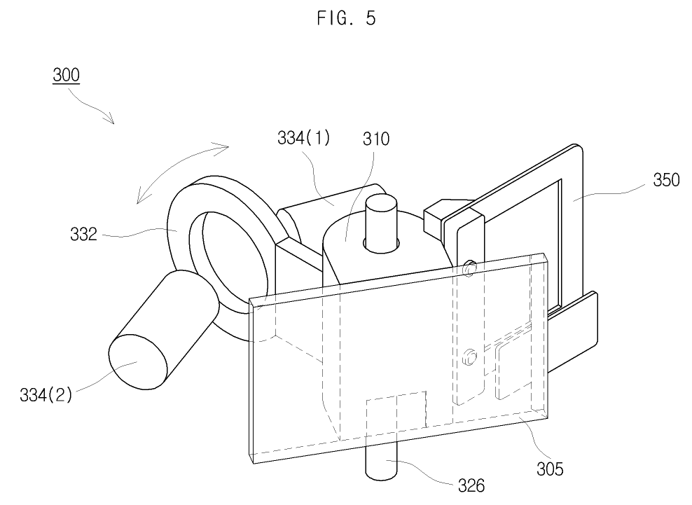

A description will now be provided as follows, with reference to FIG. 5, on the structure of a scanner according to another embodiment of the invention. FIG. 5 is a diagram of a scanner according to another embodiment of the invention.

In FIG. 5, there are illustrated a scanner 300, a mirror 305, a mirror holder 310, a housing 320, a rotational shaft 326, a driving coil 332, driving magnets 334(1), 334(2) (hereinafter collectively referred to by the numeral 334), and a supplementing part 350.

The components of the scanner 300 illustrated in FIG. 5, other than the driving coil 332 and driving magnets 334(1), 334(2) (hereinafter collectively referred to by the numeral 334), may be substantially the same as those of the scanner described above with reference to FIGS. 2 to 4, and thus redundant descriptions are omitted.

Unlike the scanner 200 illustrated in FIGS. 2 to 4, the scanner 500 illustrated in FIG. 5 can have the mirror 305 rotated by one driving coil 332 and two driving magnets 334. The mirror 305 can project light within a limited range of angles to form an image on the screen. To this end, the driving magnets 334 and the driving coil 332 can rotate the mirror holder 310 in an oscillatory manner within the limited range of angles at a particular frequency, whereby the mirror 305 secured to the mirror holder 310 may also undergo oscillatory rotations within the limited range of angles at the particular frequency. A scanner 300 such as that illustrated in FIG. 5 may generally have a lower mass than a scanner 200 illustrated in FIG. 4. As such, the moment of inertia may be reduced, so that the efficiency of the scanner 300 may be increased. The two driving magnets 334 can be secured to the housing 320 and can be formed in a symmetric arrangement with respect to the rotational shaft 326 of the mirror holder 310. The driving coil 332 can be formed on the mirror holder 310, and by regulating the amount of electric current, the magnitude of the force generated by the operation of the driving coil 332 and driving magnets 334 can be adjusted. The driving coil 332 can be coupled to the other side of the mirror holder 310 and may be moved such that the driving magnets 334 are inserted in the driving coil 332 according to changes in electric current flowing through the driving coil 332. That is, when an electric current is supplied to the driving coil 332 in one direction, the flow of electricity can generate a magnetic filed, so that the interaction between the driving coil 332 and the driving magnets 334 may create an electromagnetic force in one direction, causing a driving magnet 334 to be inserted through the driving coil 332. Conversely, when an electric current is supplied to the driving coil 332 in the opposite direction, the electromagnetic force generated by the flow of electricity in the driving coil 332 can be applied in the other direction, so that the driving magnet 334 inserted through the driving coil 332 can be removed to the exterior.

As described above, the torque generated by the driving coil 332 and the two driving magnets 334 formed symmetrically about the rotational shaft of the mirror holder 310 can provide improved linearity in the characteristics of the torque generated, compared to the conventional case of using one driving magnet and one driving coil. That is, forming the driving magnets 334 symmetrically may ensure a symmetrical property also in the characteristics of the torque generated, and the magnitude of the torque may be doubled compared to the case when only one driving magnet 334 is formed.

A description will now be provided as follows, with reference to FIG. 6, on the linearity of the torque characteristics obtained according to structure of the coils. FIG. 6 is a graph representing torque distribution for various scanner structures.

The first curve 610 and the second curve 620 represent changes in the magnitude of torque according to rotation angles, for a scanner illustrated in FIGS. 2 to 4. It is easily observed from the first and second curves 610, 620, in comparison with the third curve 630, that the torque generated by a configuration having one driving magnet and two symmetrically formed driving coils as described above may display more linear characteristics. That is, whereas a scanner using one driving coil may display a nonlinear torque distribution, the distribution of torque for the configuration having one driving magnet and two symmetrically formed driving coils may be symmetrical and may have improved linearity. It is noted that the changes in torque magnitude are different for the first curve 610 and the second curve 620. One reason for this is that the distance between the symmetrically formed driving coils are different. As shown by the second curve 620, it is possible to obtain a constant torque for the various rotation angles, by maintaining an adequate distance between the two symmetrically formed coils, so that a scanner may be provided that provides images with optimal evenness.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

1. A scanner comprising:
a mirror formed on a light path and configured to reflect incident light;
a mirror holder supporting the mirror;
a housing rotatably supporting the mirror holder;
two driving coils secured to the housing, the driving coils formed symmetrically about a rotational shaft of the mirror holder; and
a driving magnet coupled to the mirror holder, the driving magnet configured to be inserted inside the two driving coils.

2. The scanner of claim 1, further comprising a supplementing part at a position where a rotating direction of the mirror holder is changed,
the supplementing part configured to provide a supplementary rotational force supplementing a rotation of the mirror holder.

3. The scanner of claim 2, wherein the supplementing part is an elastic member configured to provide an elastic force to the mirror holder.

4. A scanner comprising:
a mirror formed on a light path and configured to reflect incident light;
a mirror holder supporting the mirror;
a housing rotatably supporting the mirror holder;
two driving magnets secured to the housing, the driving magnets formed symmetrically about a rotational shaft of the mirror holder; and
a driving coil coupled to the mirror holder, the driving coil configured to have the two driving magnets inserted therein.

5. The scanner of claim 4, further comprising a supplementing part at a position where a rotating direction of the mirror holder is changed,
the supplementing part configured to provide a supplementary rotational force supplementing a rotation of the mirror holder.

6. The scanner of claim 5, wherein the supplementing part is an elastic member configured to provide an elastic force to the mirror holder.
